(19) United States
(12) Patent Application Publication
(10) Pub. No.: US 2007/0285529 A1
(43) Pub. Date: Dec. 13, 2007

(54) Image input device, imaging module and solid-state imaging apparatus

(76) Inventors: Kunihiro Imamura, Osaka (JP); Yuki Minami, Osaka (JP)

Correspondence Address: MCDERMOTT WILL & EMERY LLP, 600 13TH STREET, NW, WASHINGTON, DC, 20005-3096, US

(21) Appl. No.: 11/802,797

(22) Filed: May 25, 2007

(30) Foreign Application Priority Data
May 29, 2006 (JP) 2006-148200

(51) Int. Cl. H04N 5/228

(52) U.S. Cl. 348/222.1

(57) ABSTRACT

The image input device for processing an imaging signal outputted from a solid-state imaging device for imaging a subject includes: first and second noise reduction sections for performing signal processing for removing or reducing a noise signal contained in the imaging signal; an illumination color temperature measurement section for measuring the illumination color temperature of the subject using the output signal of the second noise reduction section; and a YC processing section for processing an imaging signal outputted from the first noise reduction section based on a supplied video processing correction parameter that is generated based on the measured result from the illumination color temperature measurement section.

### CROSS-REFERENCE TO RELATED APPLICATIONS

This application claims priority under 35 U.S.C. §119 on Patent Application No. 2006-148200 filed in Japan on May 29, 2006, the entire contents of which are hereby incorporated by reference.

### BACKGROUND OF THE INVENTION

1. Field of the Invention

The present invention relates to an image input device for performing processing such as paralleling of an imaging signal, generation of color difference signals, generation of a luminance signal, aperture correction and gamma correction, and an imaging module and a solid-state imaging apparatus incorporating such an image input device.

2. Description of the Prior Art

In recent years, as is seen from the widespread use of mobile phones equipped with solid-state imaging apparatuses (electronic still cameras), for example, demands for smaller-size solid-state imaging apparatuses have increased. In response to the demands, image sensors have increasingly been made smaller in size, and this has caused a problem of insufficient sensitivity of image sensors.

To compensate the insufficient sensitivity of image sensors, gain correction is normally performed during A/D conversion in many cases. The gain correction however degrades S/N, and thus a noise component in an imaging signal has come to affect the imaged results too greatly to be ignored. For this reason, a solid-state imaging apparatus having a function for noise removal (noise reduction function) is being developed.

As a solid-state imaging apparatus having a noise reduction function, there is disclosed an apparatus that performs noise reduction during image data encoding compression, for example (see International Publication No. WO97/05745, for example). Such noise reduction is comparatively easy compared with improving the sensitivity of an image sensor. Therefore, technical development has been pursued vigorously for application to solid-state imaging apparatuses.

However, when illumination color temperature correction is performed using an imaging signal for which noise reduction has been made to compensate insufficient sensitivity of an image sensor, the correction may be wrong depending on the level of a remaining noise component, and thus desired imaged results may not be obtained. In reverse, when noise reduction is performed so as to ensure precise illumination color temperature correction, a high-frequency component of the imaging signal may not be secured, resulting in the imaged results having a color shift.

### SUMMARY OF THE INVENTION

An object of the present invention is providing a solid-state imaging apparatus in which illumination color temperature measurement can be performed optimally even when noise reduction is made to compensate insufficient sensitivity of an image sensor, and yet a high-frequency component of an imaging signal can be secured preventing occurrence of a color shift.

The image input device of the present invention is an image input device for processing an imaging signal outputted from a solid-state imaging device for imaging a subject and outputting the processed signal, the image input device including: first and second noise reduction sections for performing signal processing for removing or reducing a noise signal contained in the imaging signal; an illumination color temperature measurement section for measuring an illumination color temperature of the subject using an output signal of the second noise reduction section; a YC processing section for processing an imaging signal outputted from the first noise reduction section based on a supplied video processing correction parameter and outputting a processed signal; and a CPU for generating the video processing correction parameter based on a measured result from the illumination color temperature measurement section.

### BRIEF DESCRIPTION OF THE DRAWINGS

FIG. 1 is a block diagram of an electronic still camera 100 of Embodiment 1.

FIG. 2 is a block diagram showing a schematic configuration of an image sensor 105.

FIG. 3 is a cross-sectional view of part of the image sensor 105.

FIG. 4 is a block diagram of an image input device 108.

FIG. 5 is a block diagram of a first noise reduction circuit 405.

FIG. 6 is a view exemplifying specific input/output changes in sort blocks 502 and 503.

FIG. 7 is a block diagram of a second noise reduction circuit 406.

FIG. 8 is a view exemplifying specific input/output changes in sort blocks 702 and 703.

FIG. 9 is a view showing division of a screen into areas.

FIG. 10 is a block diagram of a YC processing circuit 409.

FIG. 11 is a block diagram of an image input device 1100.

FIG. 12 is a block diagram of a first noise reduction circuit 1101.

FIG. 13 is a block diagram of a second noise reduction circuit 1102.

FIG. 14 is a view showing digital imaging signals obtained when a given subject is photographed under the condition of a given illumination color temperature.

FIG. 15 is a block diagram of an image input device 1500.

FIG. 16 is a block diagram of an image input device 1600.

### DESCRIPTION OF THE PREFERRED EMBODIMENTS

Hereinafter, preferred embodiments of the present invention will be described with reference to the accompanying drawings. Note that in the following description of the embodiments, components having like functions are denoted by the same reference numerals, and the description thereof is not repeated.

### Embodiment 1

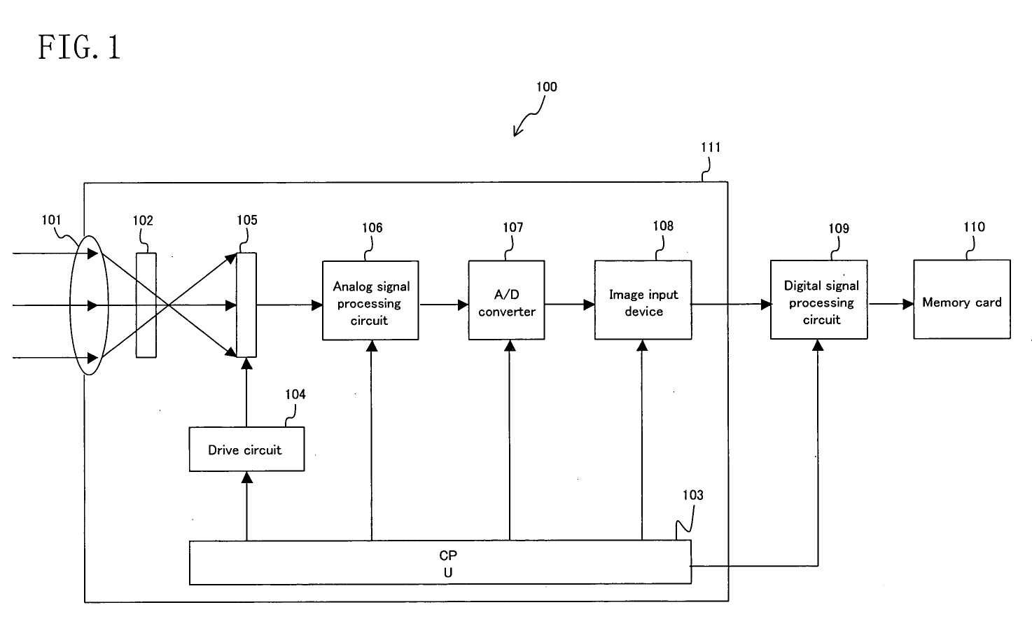

Hereinafter, an example in which the image input device of the present invention is applied to an electronic still camera (solid-state imaging apparatus) will be described. FIG. 1 is a block diagram of an electronic still camera 100 of Embodiment 1 of the present invention.

(1) Entire Configuration of Electronic Still Camera 100

As shown in FIG. 1, the electronic still camera 100 includes an optical lens 101, an infrared (IR) cut filter 102, a central processing unit (CPU) 103, a drive circuit 104, an image sensor 105, an analog signal processing circuit 106, an analog-to-digital (A/D) converter 107, an image input device 108, a digital signal processing circuit 109 and a memory card 110. Note herein that the optical lens 101, the IR cut filter 102, the CPU 103, the drive circuit 104, the image sensor 105, the analog signal processing circuit 106, the A/D converter 107 and the image input device 108 are collectively called an imaging module 111.

The optical lens 101 is placed to allow incident light from a subject to form an image on the image sensor 105.

The IR cut filter 102 removes a long-wavelength component of light incident on the image sensor 105.

The CPU 103 outputs control signals to the drive circuit 104, the analog signal processing circuit 106, the A/D converter 107, the image input device 108 and the digital signal processing circuit 109, to control the operations of these components.

The drive circuit 104 outputs drive pulses to the image sensor 105.

The image sensor 105, which is a so-called single charge coupled device (CCD), is provided with single-color filters for filtering incident light for respective photoelectric conversion elements arranged in a two-dimensional array. The image sensor 105 reads charges in the photoelectric conversion elements in response to drive pulses from the drive circuits 104 and outputs an analog imaging signal. Detailed configuration of the image sensor 105 will be described later.

The analog signal processing circuit 106 performs processing such as correlated double sampling and signal amplification for the analog imaging signal outputted from the image sensor 105.

The A/D converter 107 converts the output signal of the analog signal processing circuit 106 to a digital imaging signal.

The image input device 108 generates a digital video signal (YC signal or RGB signal) obtained by correcting a color shift of the digital imaging signal. Detailed configuration of the image input device 108 will be described later.

The digital signal processing circuit 109 includes a display circuit for displaying the digital video signal outputted from the image input device 108 to a liquid crystal display (not shown) and a control circuit for recording the video signal to the memory card 110. The digital signal processing circuit 109 displays and records the video signal according to the control signal outputted from the CPU 103.

The memory card 110 records therein the digital video signal under control of the digital signal processing circuit 109.

(2) Configuration of Image Sensor 105

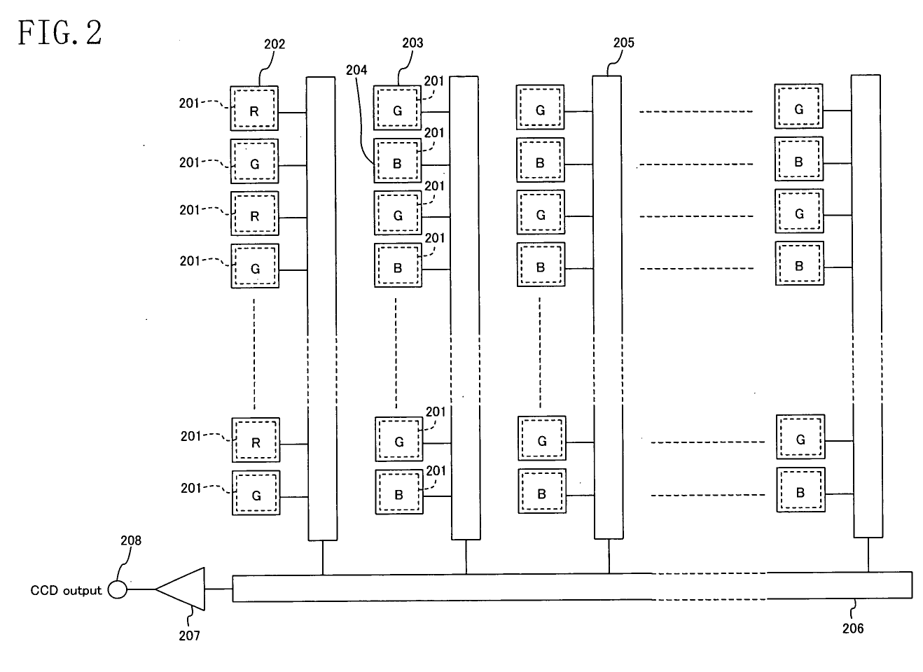

The image sensor 105 will be described in detail. FIG. 2 is a block diagram showing a schematic configuration of the image sensor 105. As shown in FIG. 2, the image sensor 105 includes photoelectric conversion elements 201, color filters 202 to 204, vertical transfer CCDs 205, a horizontal transfer CCD 206, an amplification circuit 207 and an output terminal 208.

The photoelectric conversion elements 201, which are arranged in a two-dimensional array, convert incident light to charge signals. Above each of the photoelectric conversion elements 201 placed is any one of red (R) color filters 202, green (G) color filters 203 and blue (B) color filters 204 that are arranged in Bayer array. With this placement, only a specific color component of light incident on each color filter reaches the corresponding photoelectric conversion element 201 and is converted to a charge signal.

The vertical transfer CCDs 205 transfer charge signals from respective photoelectric conversion elements 201 to the horizontal transfer CCD 206 in response to drive pulses received from the drive circuit 104.

The horizontal transfer CCD 206 also transfers charge signals from the vertical transfer CCDs 205 to the amplification circuit 207 in response to drive pulses received from the drive circuit 104.

The amplification circuit 207 converts the charge signals received from the horizontal transfer CCD 206 to a voltage signal (CCD output) and outputs the resultant signal via the output terminal 208.

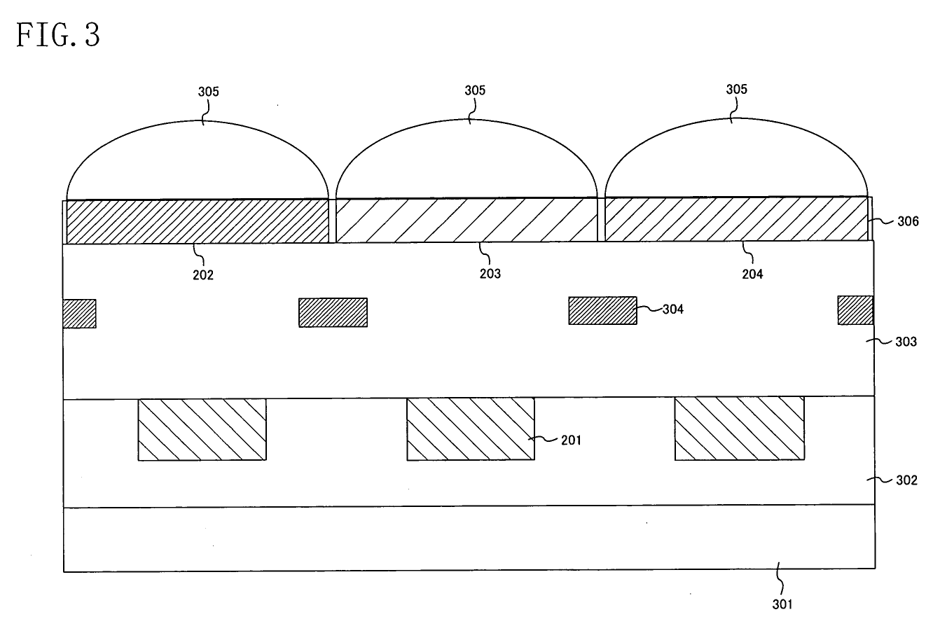

FIG. 3 is a cross-sectional view of part of the image sensor 105. In FIG. 3, the reference numeral 301 denotes an n-type semiconductor layer, 302 denotes a p-type semiconductor layer, 303 denotes an insulating film, 304 denotes light-shading films, and 305 denotes condensing lenses.

The p-type semiconductor layer 302 is formed on the n-type semiconductor layer 301, and the photoelectric conversion elements 201 are formed by ion implantation of an n-type impurity in the p-type semiconductor layer 302.

The optically transparent insulating film 303 is formed on the p-type semiconductor layer 302 and the photoelectric conversion elements 201. Inside the insulating film 303, the light-shading films 304 are provided so that only light having passed through a specific color filter is allowed to enter the corresponding photoelectric conversion element 201.

The color filters 202 to 204 are formed on the insulating film 303. The condensing lenses 305 for condensing incident light onto the photoelectric conversion elements 201 are placed on the color filters 202 to 204 at positions facing the respective photoelectric conversion elements 201.

(3) Configuration of Image Input Device 108

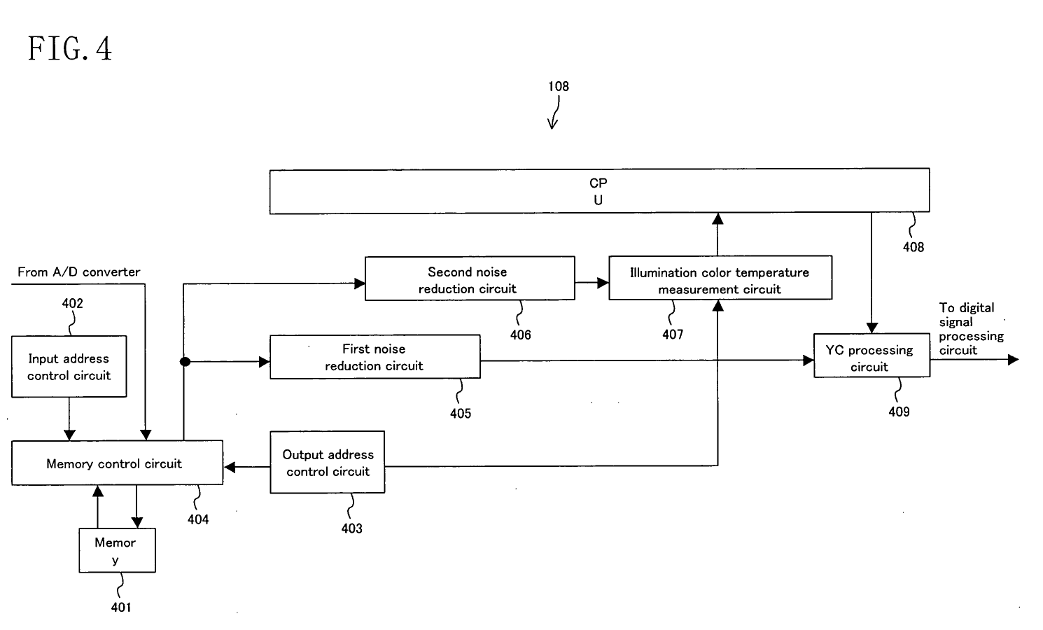

The image input device 108 will be described in detail. FIG. 4 is a block diagram of the image input device 108. As shown in FIG. 4, the image input device 108 includes a memory 401, an input address control circuit 402, an output address control circuit 403, a memory control circuit 404, a first noise reduction circuit 405, a second noise reduction circuit 406, an illumination color temperature measurement circuit 407, a CPU 408 and a YC processing circuit 409.

The memory 401 records therein a digital imaging signal outputted from the AID converter 107.

The input address control circuit 402 controls addresses used for write of the digital imaging signal into the memory 401.

The output address control circuit 403 controls addresses used for read of the digital imaging signal recorded in the memory 401.

The memory control circuit 404 generates a control signal for controlling write/read of data into/from the memory 401 in response to control signals from the input address control circuit 402 and the output address control circuit 403.

The first noise reduction circuit 405 and the second noise reduction circuit 406 perform noise reduction processing (removal or reduction of noise signal) for data (digital imaging signal) outputted from the memory control circuit 404. Detailed configuration of the first and second noise reduction circuits 405 and 406 will be described later.

The illumination color temperature measurement circuit 407 measures the illumination color temperature of a subject using a digital imaging signal noise-reduced by the second noise reduction circuit 406, and outputs the measured results (described later) to the CPU 408.

The CPU 408 determines parameters for illumination color temperature correction (video processing correction parameters) based on the measured results received from the illumination color temperature measurement circuit 407, and outputs the determined parameters to the YC processing circuit 409.

The YC processing circuit 409 performs processing, such as paralleling of a digital imaging signal, generation of color difference signals, generation of a luminance signal, aperture correction and gamma correction, for a digital imaging signal noise-reduced by the first noise reduction circuit 405 based on the video processing correction parameters received from the CPU 408, and outputs the processed results to the digital signal processing circuit 109.

(4) Configuration of First Noise Reduction Circuit 405

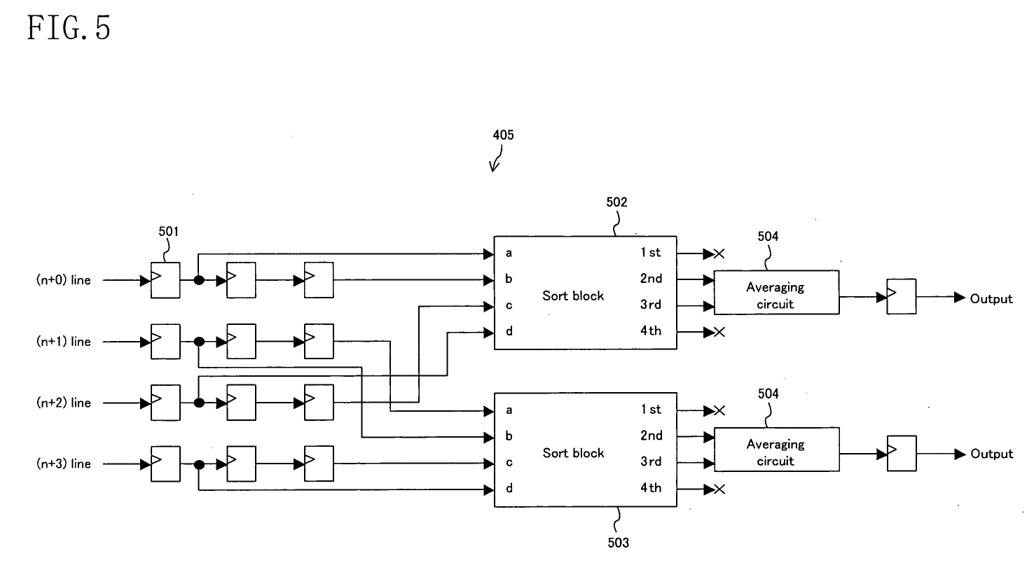

The first noise reduction circuit 405 will be described in detail. FIG. 5 is a block diagram of the first noise reduction circuit 405. As shown in FIG. 5, the first noise reduction circuit 405 includes flipflops 501 (elements having the same shape as that identified as 501 in FIG. 5 are all flipflops; clock lines for driving the flipflops are omitted), sort blocks 502 and 503 and averaging circuits 504.

The first noise reduction circuit 405 has inputs of a signal from a given pixel address as the reference (n+0 line), a signal delayed from the reference by one horizontal line (n+1 line), a signal delayed by two horizontal lines (n+2 line) and a signal delayed by three horizontal lines (n+3 line), from the memory control circuit 404.

Each of the flipflops 501 outputs a signal after delaying the signal by one pixel at a time in synchronization with the inputted clock.

Each of the sort blocks 502 and 503 receives digital imaging signals of which timing was adjusted by the memory control circuit 404 and the flipflops 501 at its terminals a, b, c and d, and outputs 1st, 2nd, 3rd and 4th signals obtained by sorting the signals inputted at the terminals a, b, c and d in increasing order. Note that in this embodiment the 1st and 4th data units are neglected.

Each of the averaging circuits 504 calculates the average value of the 2nd and 3rd values outputted from the sort block 502 or 503, and outputs the average value.

With the configuration described above, the first noise reduction circuit 405 can determine the average of the data units other than the maximum and minimum values, among a total of four data units of a given pixel, a pixel of the same color adjacent in a first horizontal direction, a pixel of the same color adjacent in a second vertical direction, and a pixel of the same color adjacent in a slanting direction defined by the first horizontal direction and the second vertical direction.

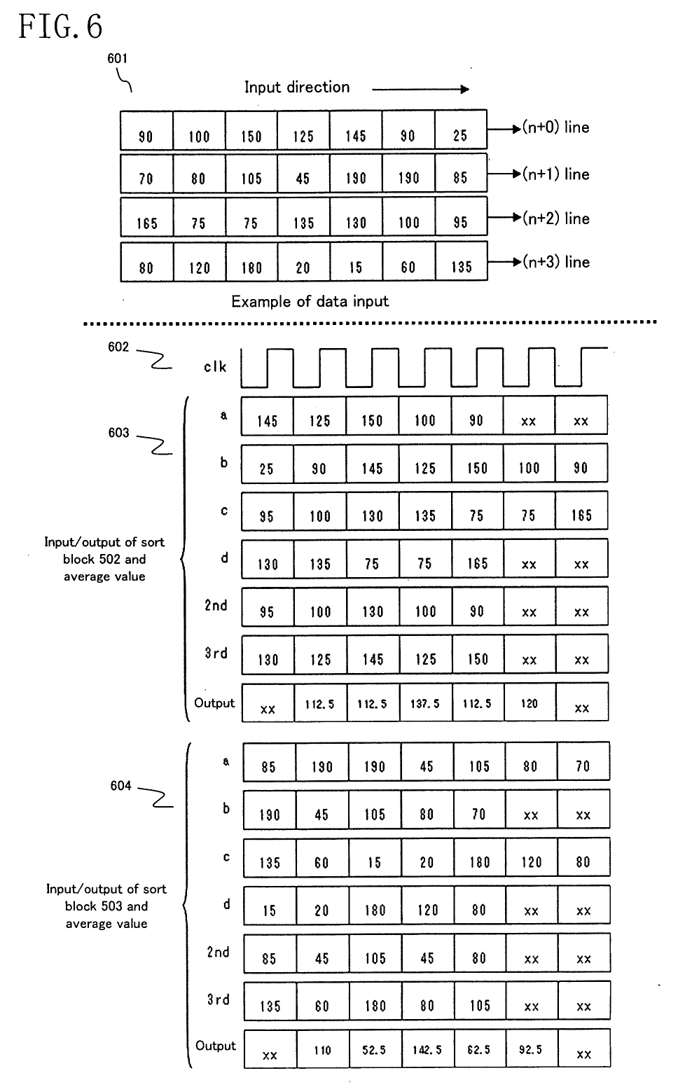

FIG. 6 is a view exemplifying specific input/output changes in the sort blocks 502 and 503. Referring to FIG. 6, the reference numeral 601 denotes time-sequence representation of signals inputted into the first noise reduction circuit 405. The reference numeral 602 denotes a clock signal for driving the flipflops 501, 603 represents input/output values of the sort block 502 together with the output of the averaging circuit 504 finally obtained, and 604 represents input/output values of the sort block 503 together with the output of the averaging circuit 504 finally obtained.

The operation will be described specifically using the first-timing portion of 603 as an example. When the data shown in 601 is inputted into the first noise reduction circuit 405, the inputs a, b, c and d of the sort block 502 respectively receive 145, 25, 95 and 130. The sort block 502 sorts the input values in increasing order and outputs 25, 95, 130 and 145 as the 1st, 2nd, 3rd and 4th values, respectively. The averaging circuit 504 receives the 2nd and 3rd values, and outputs 112.5 as the average of 95 and 130 to the flipflop at the subsequent stage.

The first noise reduction circuit 405 thus achieves noise reduction.

(5) Configuration of Second Noise Reduction Circuit 406

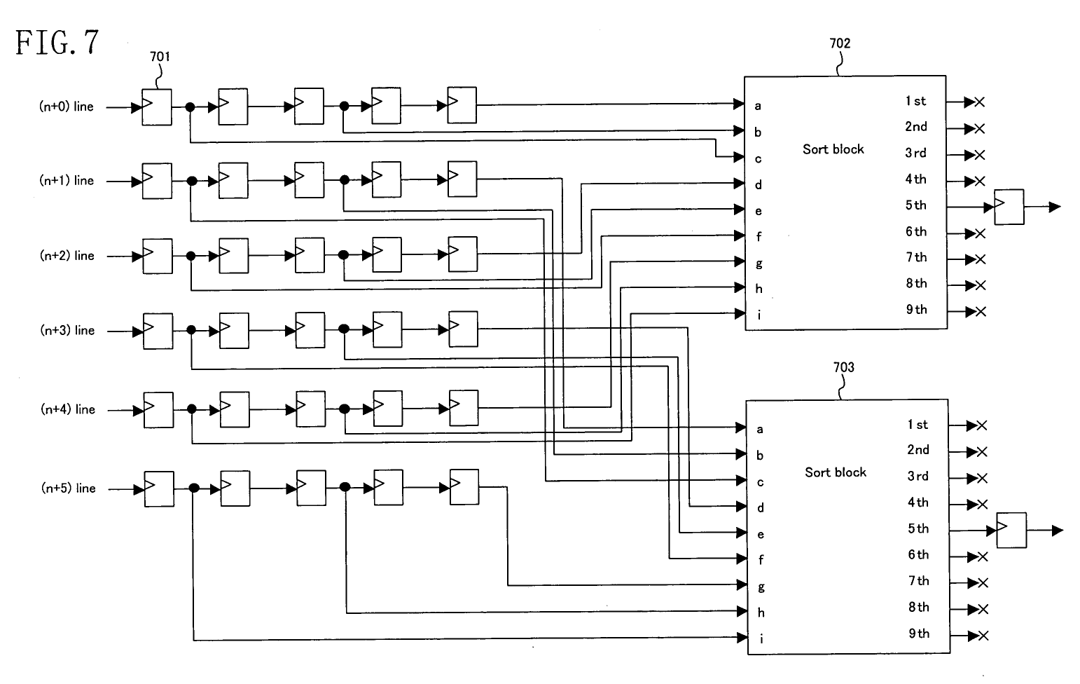

The second noise reduction circuit 406 will be described in detail. FIG. 7 is a block diagram of the second noise reduction circuit 406. As shown in FIG. 7, the second noise reduction circuit 406 includes flipflops 701 (elements having the same shape as that identified as 701 in FIG. 7 are all flipflops; clock lines for driving the flipflops are omitted), and sort blocks 702 and 703.

The second noise reduction circuit 406 has inputs of a signal from a given pixel address as the reference (n+0 line), a signal delayed from the reference by one horizontal line (n+1 line), a signal delayed by two horizontal lines (n+2 line), a signal delayed by three horizontal lines (n+3 line), a signal delayed by four horizontal lines (n+4 line) and a signal delayed by five horizontal lines (n+5 line), from the memory control circuit 404.

Each of the flipflops 701 outputs a signal after delaying the signal by one pixel at a time in synchronization with the inputted clock.

Each of the sort blocks 702 and 703 receives digital imaging signals of which timing was adjusted by the memory control circuit 404 and the flipflops 701 at its terminals a, b, c, d, e, f, g, h and i, and outputs 1st, 2nd, 3rd, 4th, 5th, 6th, 7th, 8th and 9th signals as a result of sorting of the signals inputted at the terminals a, b, c, d, e, f, g, h and i in increasing order. Note that in this embodiment the 1st to 4th and 6th to 9th data units are neglected.

With the configuration described above, the second noise reduction circuit 406 can determine the median value of a total of nine data units of a given pixel, a pixel of the same color adjacent in a first horizontal direction, a pixel of the same color adjacent in a second horizontal direction, a pixel of the same color adjacent in a first vertical direction, a pixel of the same color adjacent in a second vertical direction, a pixel of the same color adjacent in a slanting direction defined by the first horizontal direction and the first vertical direction, a pixel of the same color adjacent in a slanting direction defined by the first horizontal direction and the second vertical direction, a pixel of the same color adjacent in a slanting direction defined by the second horizontal direction and the first vertical direction, and a pixel of the same color adjacent in a slanting direction defined by the second horizontal direction and the second vertical direction.

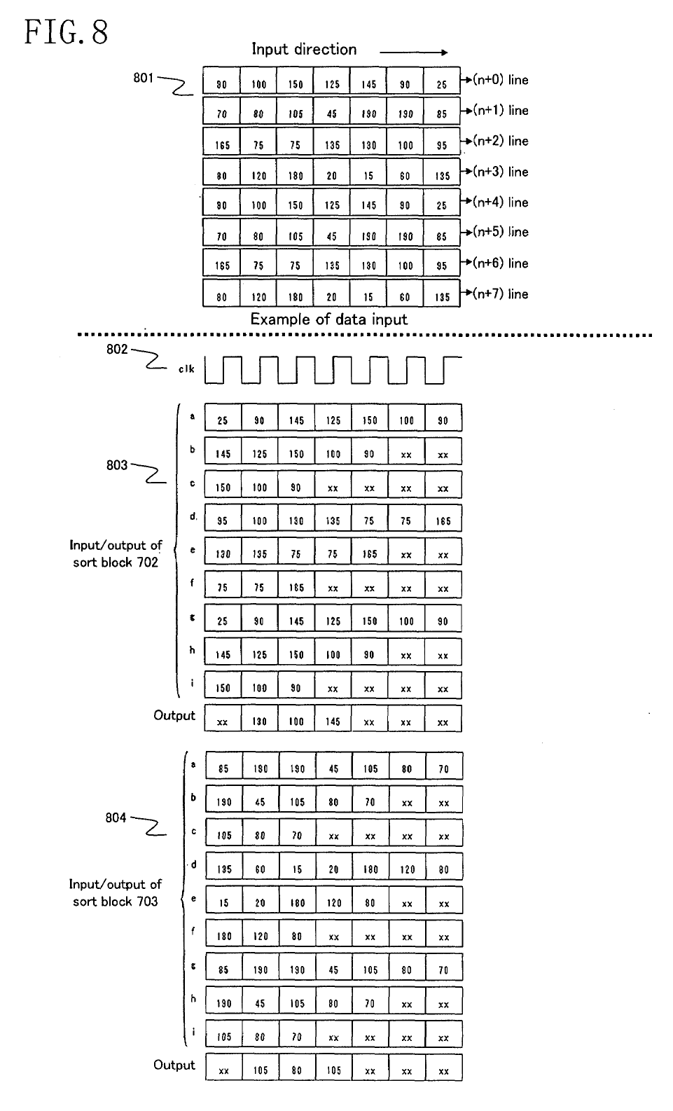

FIG. 8 is a view exemplifying specific input/output changes in the sort blocks 702 and 703. In FIG. 8, the reference numeral 801 denotes time-sequence representation of signals inputted into the second noise reduction circuit 406. The reference numeral 802 denotes a clock signal for driving the flipflops 701, 803 represents input/output values of the sort block 702 together with the median value finally obtained, and 804 represents input/output values of the sort block 703 together with the median value finally obtained.

The specific operation will be described using the first-timing portion of 803 as an example. When the data shown in 801 is inputted into the second noise reduction circuit 406, the inputs a, b, c, d, e, f, g, h and i of the sort block 702 respectively receive values 25, 145, 150, 95, 130, 75, 25, 145 and 150. The sort block 702 sorts the input values in increasing order and outputs 25, 25, 75, 95, 130, 145, 145, 150 and 150 as the 1st, 2nd, 3rd, 4th, 5th, 6th, 7th, 8th and 9th values, respectively. The 5th value is then supplied to the flipflop at the subsequent stage, neglecting the 1st to 4th and 6th to 9th values.

The second noise reduction circuit 406 thus achieves noise reduction.

Note that since the noise reduction in the second noise reduction circuit 406 does not require so much consideration to the frequency characteristic and the like, it may be simpler than in the first noise reduction circuit 405. The “simpler” noise reduction as used herein means that the improvement level of noise is comparatively small, the complexity of noise reduction processing is comparatively low, or the circuit scale is comparatively small.

(6) Configuration of Illumination Color Temperature Measurement Circuit 407 and CPU 408

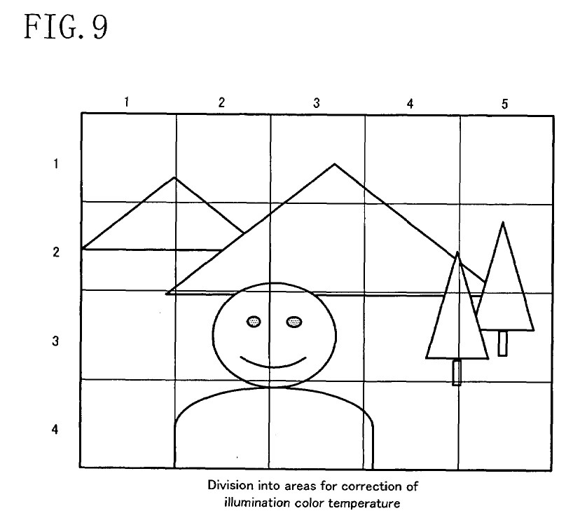

The illumination color temperature measurement circuit 407 will be described in detail. The illumination color temperature circuit 407 divides the screen into areas as shown in FIG. 9, accumulates R, G and B components of the digital imaging signal outputted from the second noise reduction circuit 406 (noise-reduced digital imaging signal) individually for each area every vertical retrace time, and outputs the accumulated results for each area to the CPU 408 as the measured results.

The CPU 408 determines whether the area concerned is chromatic or achromatic based on the accumulated results of the R, G and B components. The CPU 408 outputs video processing correction parameters (specifically, coefficients j, k, l, m, n, o, p, q and r described later) to the YC processing circuit 409 based on the accumulated results of an area determined as achromatic.

(7) Configuration of YC Processing Circuit 409

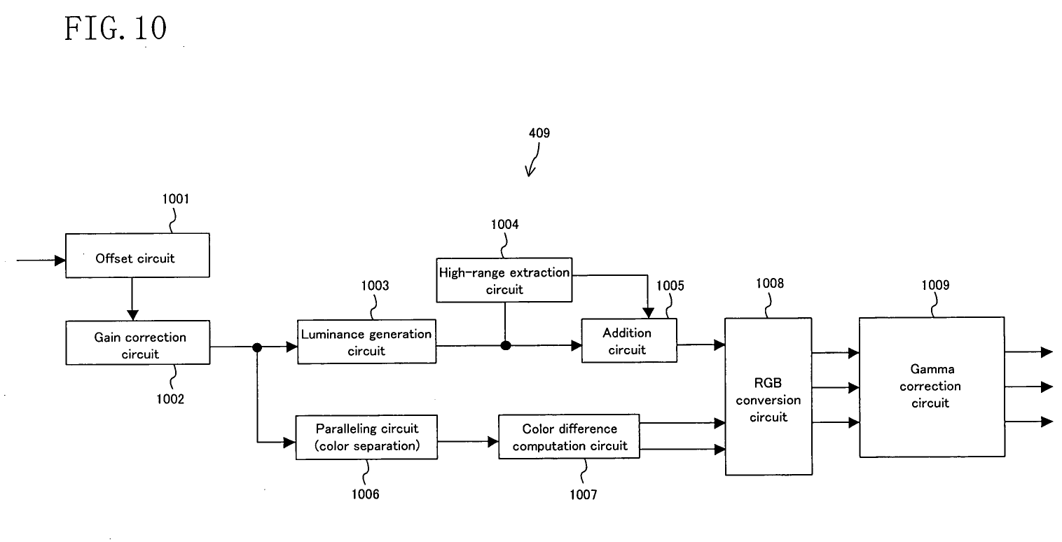

The YC processing circuit 409 will be described in detail. FIG. 10 is a block diagram of the YC processing circuit 409.

The YC processing circuit 409 includes an offset circuit 1001, a gain correction circuit 1002, a luminance generation circuit 1003, a high-range extraction circuit 1004, an addition circuit 1005, a paralleling circuit 1006 (color separation), a color difference computation circuit 1007, an RGB conversion circuit 1008 and a gamma correction circuit 1009.

The offset circuit 1001 corrects the offset level of the digital imaging signal outputted from the first noise reduction circuit 405 by adding/subtracting a predetermined value to/from the digital imaging signal.

The gain correction circuit 1002 performs gain correction for the output of the offset circuit 1001 (offset level-corrected digital imaging signal), to correct the digital imaging signal to an appropriate signal level.

The luminance generation circuit 1003 generates a luminance signal from inputted R, G and B signals by computing

(Luminance signal)=0.3*(R signal)+0.59*(G signal)+0.11*(B signal).

The high-range extraction circuit 1004 performs the following processing for the luminance signal generated by the luminance generation circuit 1003. That is, the high-range extraction circuit 1004 performs band-pass filtering for the luminance signal to extract a high-frequency component from the luminance signal, performs coring processing to remove a minute noise component extracted by the band-pass filtering, and further performs gain correction for the cored signal to obtain an appropriate signal level.

The addition circuit 1005 adds the high-frequency component of the luminance signal received from the high-range extraction circuit 1004 to the luminance signal received from the luminance generation circuit 1003, to correct the high-frequency component of the luminance signal degraded due to the lenses, signal processing and the like.

The paralleling circuit 1006 permits R, G and B signals received from the gain correction circuit 1002 to synchronize with one another, to thereby generate R, G and B signals corresponding to the same pixel address and pixel centroid as those of the luminance signal generated by the luminance generation circuit 1003.

The color difference computation circuit 1007 generates an R−Y signal and a B−Y signal from the R, G and B signals generated by the paralleling circuit 1006 by computing

(R−Y signal)=0.7*(R signal)−0.59*(G signal)−0.11*(B signal)

(B−Y signal)=0.3*(R signal)−0.59*(G signal)+0.89*(B signal).

The RGB conversion circuit 1008 generates R, G and B signals from the high-frequency component-corrected luminance signal, the R−Y signal and the B−Y signal by computing

R=j*(luminance signal)+k*(R−Y signal)+l*(B−Y signal)

G=m*(luminance signal)+n*(R−Y signal)+o*(B−Y signal)

B=p*(luminance signal)+q*(R−Y signal)+r*(B−Y signal).

### The coefficients j, k, l, m, n, o, p, q and r used for the computation are received from the CPU 408.

The gamma correction circuit 1009 corrects the R, G and B signals received from the RGB conversion circuit 1008 so as to obtain a characteristic reverse to the gamma characteristic of the display device (not shown), to thereby correct the gamma characteristic of the display device.

When an image is taken with the electronic still camera 100 described above, incident light from a subject forms an image on the image sensor 105 via the optical lens 101 and the IR cut filter 102. The image sensor 105 outputs an analog imaging signal to the analog signal processing circuit 106, where the analog imaging signal is subjected to processing such as correlated double sampling and signal amplification and then outputted to the A/D converter 107. The A/D converter 107 converts the output signal of the analog signal processing circuit 106 to a digital imaging signal and outputs the signal to the image input device 108.

In the image input device 108, the digital imaging signal is subjected to noise reduction processing by the second noise reduction circuit 406 for precise recognition of an achromatic portion, and then parameters for performing processing such as paralleling of the imaging signal, generation of color difference signals, generation of a luminance signal, aperture correction and gamma correction are prepared by the illumination color temperature measurement circuit 407 and the CPU 408, and set in the YC processing circuit 409.

The digital imaging signal is also inputted in the first noise reduction circuit 405 for noise reduction, and then subjected to the processing such as paralleling of the imaging signal, generation of color difference signals, generation of a luminance signal, aperture correction and gamma correction by the YC processing circuit 409. The resultant signal is then outputted to the digital signal processing circuit 109. The digital signal processing circuit 109 displays the output of the image input device 108 to a liquid crystal display (not shown) or records the output in the memory card 110.

As described above, in this embodiment, the digital imaging signal used for display and recording and the digital imaging signal used for illumination color temperature correction are separately subjected to noise reduction. It is therefore possible to provide the electronic still camera 100 permitting optimum illumination color temperature measurement and capable of securing a high-frequency component of the video signal to prevent occurrence of a color shift.

### Embodiment 2

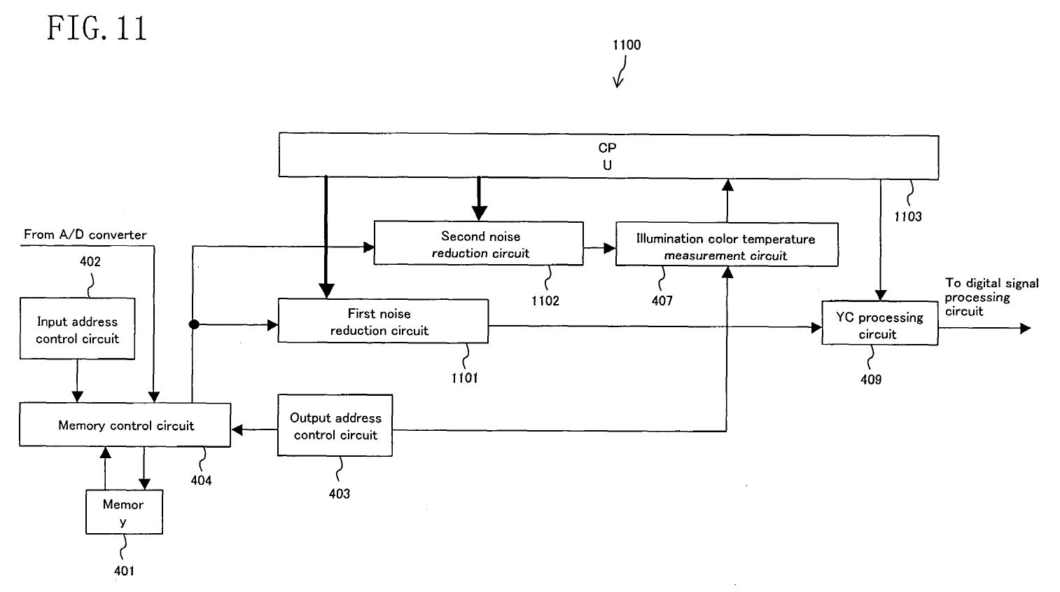

The electronic still camera 100 may include an image input device 1100 shown in FIG. 11 as a block diagram, in place of the image input device 108.

(1) Entire Configuration of Image Input Device 1100

As shown in FIG. 11, the image input device 1100 includes the memory 401, the input address control circuit 402, the output address control circuit 403, the memory control circuit 404, the illumination color temperature measurement circuit 407, the YC processing circuit 409, a first noise reduction circuit 1101, a second noise reduction circuit 1102 and a CPU 1103.

The first noise reduction circuit 1101 performs noise reduction processing for a digital imaging signal read by the memory control circuit 404 according to a control signal (described later) outputted from the CPU 1103.

The second noise reduction circuit 1102 performs noise reduction processing for the digital imaging signal read by the memory control circuit 404 according to a control signal (described later) outputted from the CPU 1103.

The CPU 1103, like the CPU 408, determines parameters for illumination color temperature correction (video processing correction parameters) based on the measured results received from the illumination color temperature measurement circuit 407, and outputs the determined parameters to the YC processing circuit 409. The CPU 1103 further controls the first noise reduction circuit 1101 and the second noise reduction circuit 1102 (as described later).

(2) Configuration of First Noise Reduction Circuit 1101

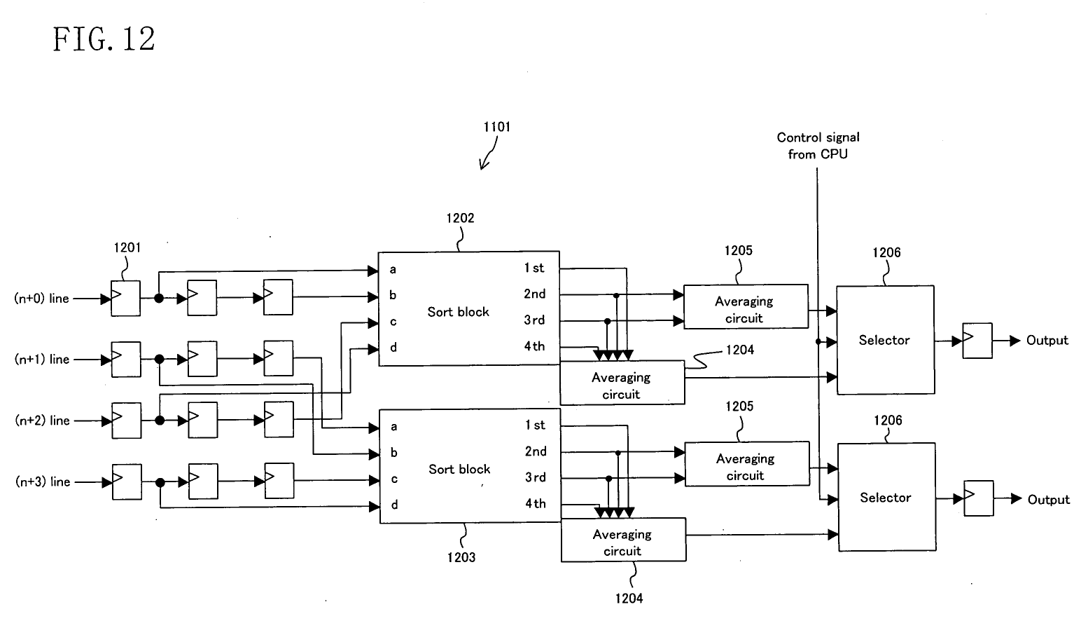

The first noise reduction circuit 1101 will be described in detail. FIG. 12 is a block diagram of the first noise reduction circuit 1101. As shown in FIG. 12, the first noise reduction circuit 1101 includes flipflops 1201 (elements having the same shape as that identified as 1201 in FIG. 12 are all flipflops; clock lines for driving the flipflops are omitted), sort blocks 1202 and 1203, averaging circuits 1204 and 1205, and selectors 1206.

The first noise reduction circuit 1101 has inputs of a signal from a given pixel address as the reference (n+0 line), a signal delayed from the reference by one horizontal line (n+1 line), a signal delayed by two horizontal lines (n+2 line) and a signal delayed by three horizontal lines (n+3 line), from the memory control circuit 404.

Each of the flipflops 1201 outputs a signal after delaying the signal by one pixel at a time in synchronization with the inputted clock.

Each of the sort blocks 1202 and 1203 receives digital imaging signals of which timing was adjusted by the memory control circuit 404 and the flipflops 1201 at its terminals a, b, c and d, and outputs 1st, 2nd, 3rd and 4th signals obtained by sorting the signals inputted at the terminals a, b, c and d in increasing order.

Each of the averaging circuits 1204 calculates the average of the four values, i.e., 1st, 2nd, 3rd and 4th values outputted from the sort block 1202 (or 1203), and outputs the average value.

Each of the averaging circuits 1205 calculates the average of two values, i.e., 2nd and 3rd values outputted from the sort block 1202 (or 1203), and outputs the average value.

With the configuration described above, the first noise reduction circuit 1101 can determine a first average value that is the average of data units other than the maximum and minimum values, among a total of four data units of a given pixel, a pixel of the same color adjacent in a first horizontal direction, a pixel of the same color adjacent in a second vertical direction, and a pixel of the same color adjacent in a slanting direction defined by the first horizontal direction and the second vertical direction. Also, the first noise reduction circuit 1101 can determine a second average value that is the average of the four data units of the given pixel, the pixel of the same color adjacent in a first horizontal direction, the pixel of the same color adjacent in a second vertical direction, and the pixel of the same color adjacent in a slanting direction defined by the first horizontal direction and the second vertical direction.

Each of the selectors 1206, receiving a control signal outputted from the CPU 1103, selects either one of the first and second average values and outputs the selected value.

(3) Configuration of Second Noise Reduction Circuit 1102

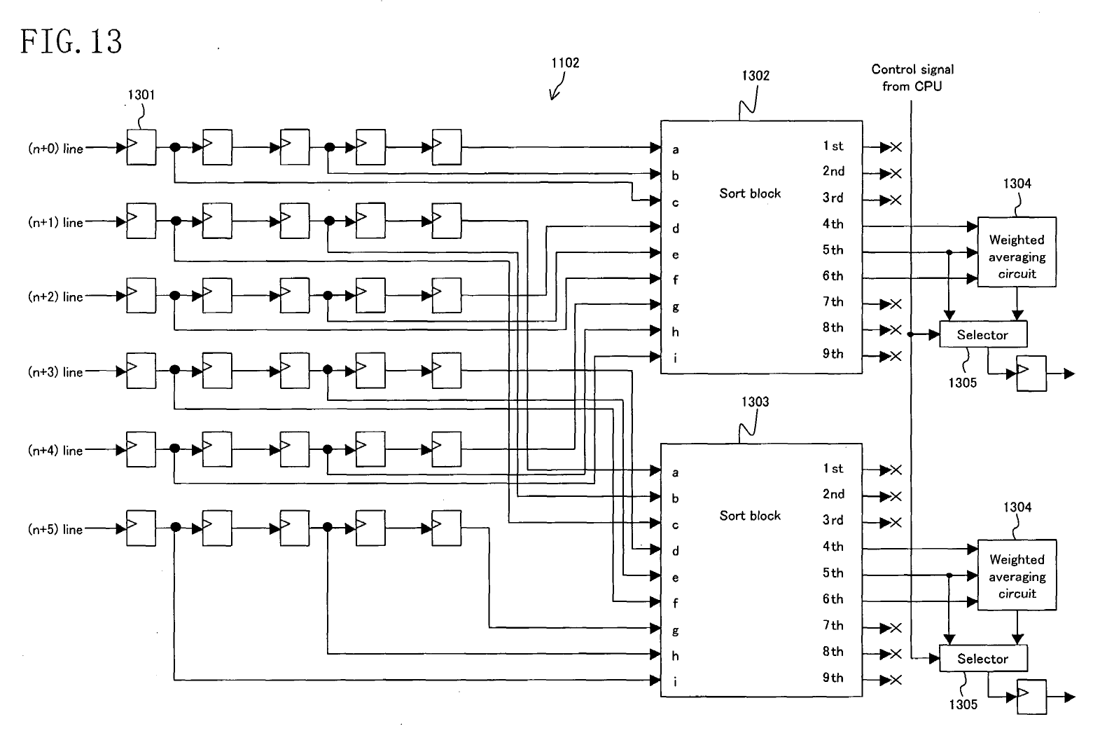

The second noise reduction circuit 1102 will be described in detail. FIG. 13 is a block diagram of the second noise reduction circuit 1102. As shown in FIG. 13, the second noise reduction circuit 1102 includes flipflops 1301 (elements having the same shape as that identified as 1301 in FIG. 13 are all flipflops; clock lines for driving the flipflops are omitted), sort blocks 1302 and 1303, weighted averaging circuits 1304, and selectors 1305.

The second noise reduction circuit 1102 has inputs of a signal from a given pixel address as the reference (n+0 line), a signal delayed from the reference by one horizontal line (n+1 line), a signal delayed by two horizontal lines (n+2 line), a signal delayed by three horizontal lines (n+3 line), a signal delayed by four horizontal lines (n+4 line) and a signal delayed by five horizontal lines (n+5 line), from the memory control circuit 404.

Each of the flipflops 1301 outputs a signal after delaying the signal by one pixel at a time in synchronization with the inputted clock.

Each of the sort blocks 1302 and 1303 receives digital imaging signals of which timing was adjusted by the memory control circuit 404 and the flipflops 1301 at its terminals a, b, c, d, e, f, g, h and i, and outputs 1st, 2nd, 3rd, 4th, 5th, 6th, 7th, 8th and 9th signals as a result of sorting of the signals inputted at the terminals a, b, c, d, e, f, g, h and i in increasing order. Note that in this embodiment the 1st to 3rd and 7th to 9th data units are neglected.

With the configuration described above, the second noise reduction circuit 1102 can determine the median value of a total of nine data units of a given pixel, a pixel of the same color adjacent in a first horizontal direction, a pixel of the same color adjacent in a second horizontal direction, a pixel of the same color adjacent in a first vertical direction, a pixel of the same color adjacent in a second vertical direction, a pixel of the same color adjacent in a slanting direction defined by the first horizontal direction and the first vertical direction, a pixel of the same color adjacent in a slanting direction defined by the first horizontal direction and the second vertical direction, a pixel of the same color adjacent in a slanting direction defined by the second horizontal direction and the first vertical direction, and a pixel of the same color adjacent in a slanting direction defined by the second horizontal direction and the second vertical direction.

Also, the second noise reduction circuit 1102 can obtain the fourth, fifth and sixth data units, among the nine data units of the given pixel, the pixel of the same color adjacent in a first horizontal direction, the pixel of the same color adjacent in a second horizontal direction, the pixel of the same color adjacent in a first vertical direction, the pixel of the same color adjacent in a second vertical direction, the pixel of the same color adjacent in a slanting direction defined by the first horizontal direction and the first vertical direction, the pixel of the same color adjacent in a slanting direction defined by the first horizontal direction and the second vertical direction, the pixel of the same color adjacent in a slanting direction defined by the second horizontal direction and the first vertical direction, and the pixel of the same color adjacent in a slanting direction defined by the second horizontal direction and the second vertical direction.

Each of the weighted averaging circuits 1304 performs weighted addition and averaging for the fourth, fifth and sixth data units outputted from the sort block 1302 (or 1303), and outputs the average value.

Each of the selectors 1305 selects either one of the median value and the weighted average value in response to a control signal outputted from the CPU 1103 and outputs the selected one.

(4) Configuration of CPU 1103

The CPU 1103 changes the coefficients j, k, l, m, n, o, p, q and r supplied to the YC processing circuit 409 depending on the control signals supplied to the first and second noise reduction circuits 1101 and 1102.

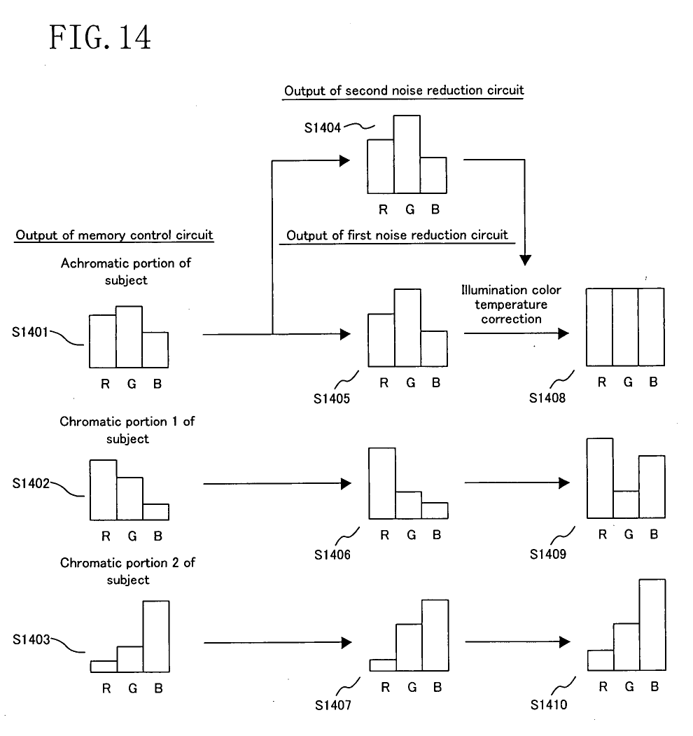

FIG. 14 shows digital imaging signals (S1401 to S1410) obtained when a given subject is photographed under the condition of a given illumination color temperature. The signal S1401 represents the output of an achromatic portion of the subject, the signals S1402 and S1403 represent chromatic portions of the subject. The R, G and B of each signal are based on the ratio among the outputs from the color filters R, G and B.

The signal S1401 is inputted into the second noise reduction circuit 1102 and changed to a signal S1404 by being subjected to the noise reduction processing thereof. The signal S1401 is also inputted into the first noise reduction circuit 1101 and changed to a signal S1405 by being subjected to the noise reduction processing thereof.

In the above noise reduction, the CPU 1103 controls the first and second noise reduction circuits 1101 and 1102 so that the noise reduction results of the achromatic portion from the first noise reduction circuit 1101 and the noise reduction results thereof from the second noise reduction circuit 1102 are equal to each other.

The signals S1402 and S1403 of the chromatic portions are inputted into the first noise reduction circuit 1101 and changed to signals S1406 and S1407, respectively, by being subjected to the noise reduction processing thereof.

In the above noise reduction, as shown in FIG. 14, a distortion occurs in the ratio among R, G and B between the signals S1402 and S1406 and between the signals S1403 and S1407.

To address the above problem, the CPU 1103 prepares video processing correction parameters for illumination color temperature correction so that a corrected signal is achromatic, based on the signal S1404, and outputs the resultant parameters to the YC processing circuit 409.

The illumination color temperature correction is performed based on the image processing correction parameters, so that the outputs of the achromatic and chromatic portions of the subject are changed to outputs represented by signals S1408, S1409 and S1410. In this correction, while a desired output is obtained for the achromatic portion, a distortion still remains for the chromatic portions. To correct the distortion, the CPU 1103 changes the values of the coefficients j, k, l, m, n, o, p, q and r. In this way, a desired video signal can be obtained.

As described above, in this embodiment, the digital imaging signal used for display and recording and the digital imaging signal used for illumination color temperature correction are separately subjected to noise reduction processing. It is therefore possible to provide the electronic still camera 100 permitting optimum illumination color temperature measurement and capable of securing a high-frequency component of the video signal to prevent occurrence of a color shift.

Also, in this embodiment, in which the CPU 1103 can control the noise removal characteristics of the first and second noise reduction circuits 1101 and 1102, detailed adjustment of the noise component removal characteristics in response to the photographing conditions can be made.

With the individual control of the noise removal characteristics of the two-route noise reduction circuits by the CPU, it is possible to control the respective noise characteristics of the imaging signal used for display and recording and the imaging signal used for illumination light temperature measurement. In this embodiment, therefore, more detailed image correction can be made.

By configuring so that the CPU controls the noise removal characteristics of the two-route noise reduction circuits simultaneously, complicated setting work during photographing can be lessened.

By configuring so that the CPU sets the noise removal characteristics of one of the two-route noise reduction circuits in association with the noise removal characteristics of the other based on external setting, complicated setting work during photographing can be lessened.

In the noise reduction circuits in this embodiment, the selector switches between two output results. Alternatively, the selection may be made among three or more output results. Otherwise, two or more output results may be weighted, added and then averaged.

The coefficients j, k, l, m, n, o, p, q and r for correction of color distortions may be changed depending on the ratio among RGB of the inputted imaging signal.

The color space to be calculated may be divided into a plurality of areas, and the coefficients j, k, l, m, n, o, p, q and r may be changed for each of the divided color space areas.

The coefficients j, k, l, m, n, o, p, q and r for correction of color distortions may be stored in a memory device (not shown) in advance, and the CPU may read them from the memory device for use according to the noise removal characteristics of the noise reduction circuit to be set.

The coefficients j, k, l, m, n, o, p, q and r for correction of color distortions may be stored in a memory device (not shown) in advance as discrete values, and the CPU may calculate coefficients j, k, l, m, n, o, p, q and r for correction of color distortions using the values read from the memory device according to the noise removal characteristics of the noise reduction circuit to be set. This permits more detailed correction of a color shift.

The coefficients j, k, l, m, n, o, p, q and r may be determined by performing computation for video processing correction parameters used during photographing of the subject.

The first and second noise reduction circuits 1101 and 1102 are not necessarily different in circuit configuration from each other as described above. For example, the first noise reduction circuit 1101 may have the same circuit configuration as the second noise reduction circuit 1102, and the CPU 1103 may control the noise removal characteristics. This permits individual noise reduction processing for the imaging signal used for display and recording and the imaging signal used for illumination color temperature correction without the necessity of providing a new noise reduction circuit.

### Embodiment 3

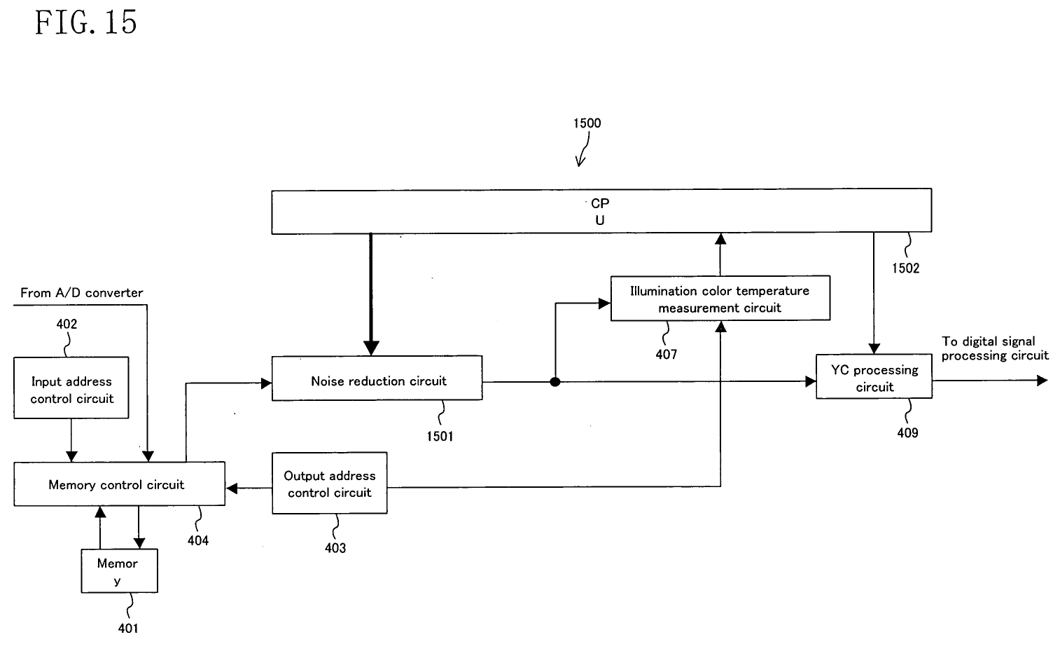

The electronic still camera 100 may include an image input device 1500 shown in FIG. 15 as a block diagram, in place of the image input device 108.

As shown in FIG. 15, the image input device 1500 includes the memory 401, the input address control circuit 402, the output address control circuit 403, the memory control circuit 404, the illumination color temperature measurement circuit 407, the YC processing circuit 409, a noise reduction circuit 1501 and a CPU 1502.

The noise reduction circuit 1501 performs noise reduction processing for the digital imaging signal read by the memory control circuit 404 according to a control signal outputted from the CPU 1502. Specifically, the noise reduction circuit 1501 has the same circuit configuration as the second noise reduction circuit 1102, which includes the flipflops 1301, the sort blocks 1302 and 1303, the weighted averaging circuits 1304 and the selectors 1305.

The CPU 1502, like the CPU 408, determines parameters for illumination color temperature correction (video processing correction parameters) based on the measured results received from the illumination color temperature measurement circuit 407, and outputs the determined parameters to the YC processing circuit 409. Further, the CPU 1502 controls the noise removal characteristics of the noise reduction circuit 1501 depending on whether the digital imaging signal noise-reduced by the noise reduction circuit 1501 is to be used for display and recording or for the illumination color temperature correction.

With the above configuration, in this embodiment, as in the above embodiments, noise reduction processing can be performed separately for the digital imaging signal used for display and recording and the digital imaging signal used for illumination color temperature correction.

Moreover, in this embodiment, the electronic still camera can be configured in a smaller circuit scale than in Embodiments 1 and 2, and thus lower cost and lower power consumption can be attained.

### Embodiment 4

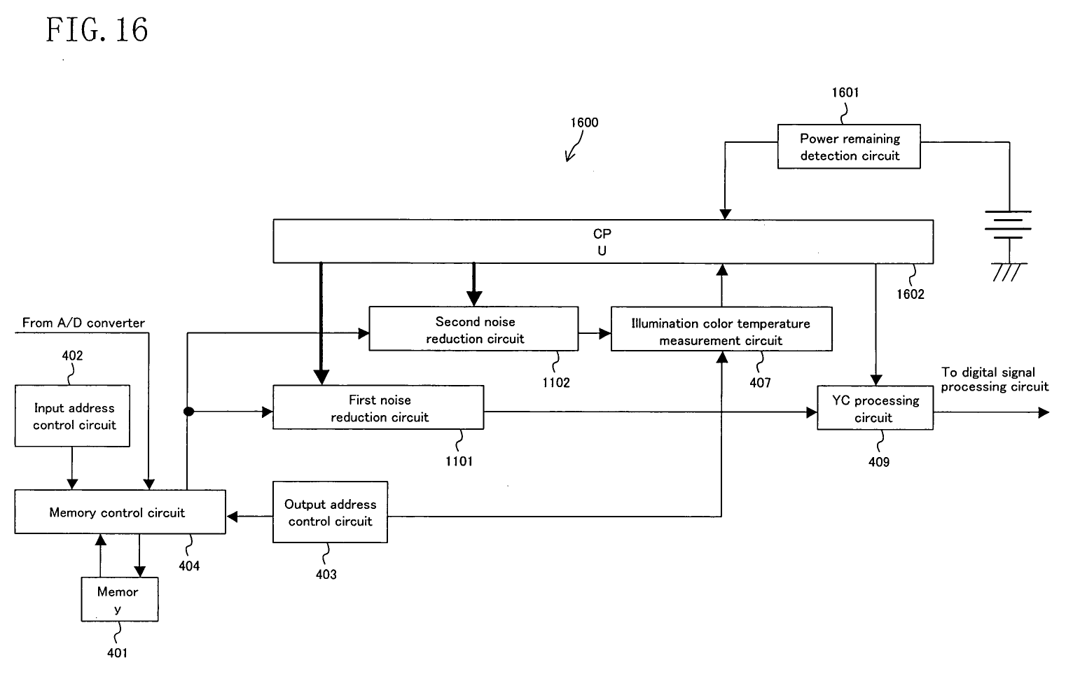

The electronic still camera 100 may include an image input device 1600 shown in FIG. 16 as a block diagram, in place of the image input device 108.

As shown in FIG. 16, the image input device 1600 includes the memory 401, the input address control circuit 402, the output address control circuit 403, the memory control circuit 404, the illumination color temperature measurement circuit 407, the YC processing circuit 409, the first noise reduction circuit 1101, the second noise reduction circuit 1102, a power remaining detection circuit 1601 and a CPU 1602.

The power remaining detection circuit 1601 detects the remaining amount of power supplied to the electronic still camera and notifies the CPU 1602 of the value of the remaining amount.

The CPU 1602, like the CPU 408, determines parameters for illumination color temperature correction (video processing correction parameters) based on the measured results received from the illumination color temperature measurement circuit 407, and outputs the determined parameters to the YC processing circuit 409. Further, the CPU 1602 controls the noise removal characteristics of the first and second noise reduction circuits 1101 and 1102, ON/OFF of the noise reduction processing and ON/OFF of the clock supplied to the first and second noise reduction circuits 1101 and 1102, based on the value of the remaining amount of power notified by the power remaining detection circuit 1601.

With the above configuration, in this embodiment, as in the above embodiments, noise reduction processing can be performed separately for the digital imaging signal used for display and recording and the digital imaging signal used for illumination color temperature correction.

Moreover, in this embodiment, it is possible to configure an electronic still camera capable of effectively saving power consumption.

The embodiments described above can be modified in various ways. For example, the image sensor 105 may be a CMOS sensor or a CCD sensor.

The color filters of the image sensor may be of the complementary colors or the primary colors. The color filter array is not necessarily Bayer array.

The read method of the image sensor may be an interlace scan method, a progressive scan method, a pixel thinning method, or a method in which pixels are mixed and read.

Three or more noise reduction circuits may be provided.

The components in the above embodiments may be combined in various ways as long as such combinations are logically allowed. For example, the power remaining detection circuit 1601 may be provided in the image input device 108.

In the above embodiments, the noise reduction processing was implemented by hardware (circuit). Alternatively, this processing may be implemented by software.

As described above, the image input device of the present invention has the effect that even when noise reduction is made to compensate insufficient sensitivity of the image sensor, the illumination color temperature measurement can be performed optimally and a high-frequency component of a video signal can be secured preventing occurrence of a color shift. Thus, the present invention is applicable to an image input device that performs processing such as paralleling of an imaging signal, generation of color difference signals, generation of a luminance signal, aperture correction and gamma correction, and an imaging module and a solid-state imaging apparatus incorporating such an image input device.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. An image input device for processing an imaging signal outputted from a solid-state imaging device for imaging a subject and outputting the processed signal, the image input device comprising:
first and second noise reduction sections for performing signal processing for removing or reducing a noise signal contained in the imaging signal;
an illumination color temperature measurement section for measuring an illumination color temperature of the subject using an output signal of the second noise reduction section;
a YC processing section for processing an imaging signal outputted from the first noise reduction section based on a supplied video processing correction parameter and outputting a processed signal; and
a CPU for generating the video processing correction parameter based on a measured result from the illumination color temperature measurement section.

2. The device of claim 1, wherein the first and second noise reduction sections are configured of hardware independent of each other or software independent of each other, and the signal processing performed by one of the noise reduction sections is different from that performed by the other.

3. The device of claim 1, wherein the first and second noise reduction sections are configured so that ON/OFF of noise removal and the strength of noise removal can be set in response to external setting.

4. The device of claim 3, wherein the first and second noise reduction sections are configured so that ON/OFF of noise removal and the strength of noise removal can be set individually.

5. The device of claim 3, wherein ON/OFF of noise removal or the strength of noise removal of the second noise reduction section is set in association with noise removal characteristics of the first noise reduction section.

6. The device of claim 1, wherein the first and second noise reduction sections are configured of hardware independent of each other or software independent of each other, and the signal processing performed by one of the noise reduction sections is the same as that performed by the other.

7. The device of claim 1, wherein the first and second noise reduction sections are configured of a single hardware unit.

8. The device of claim 1, wherein the video processing correction parameter is changed depending on noise removal results of the first and second noise reduction sections.

9. The device of claim 8, wherein the video processing correction parameter is determined by performing computation for a video processing correction parameter used during imaging of a subject.

10. The device of claim 8, further comprising a video processing correction parameter storage section for storing therein a plurality of video processing correction parameters,
wherein the YC processing section receives a video processing correction parameter selected among the video processing correction parameters stored in the video processing correction parameter storage section according to noise removal results from the first and second noise reduction sections.

11. The device of claim 1, wherein the first and second noise reduction sections are configured so that ON/OFF of noise removal and the strength of noise removal can be set according to power supplied.

12. The device of claim 1, wherein the first and second noise reduction sections are configured of hardware independent of each other, and
the second noise reduction section is smaller in circuit configuration than the first noise reduction section.

13. The device of claim 1, wherein the second noise reduction section is configured to is perform simpler signal processing than the first noise reduction section.

14. An imaging module comprising:
the image input device of claim 1;
a solid-state imaging device; and
a lens.

15. A solid-state imaging apparatus comprising:
the imaging module of claim 14; and
a digital signal processing circuit for recording or displaying a signal outputted from the imaging module.
